(19) United States
(12) Patent Application Publication
(10) Pub. No.: US 2018/0017748 A1
(43) Pub. Date: Jan. 18, 2018

(54) A METHOD AND APPARATUS FOR INTERCONNECTING PHOTONIC CIRCUITS

(71) Applicants: Mehrdad MIR SHAFIEI, Montreal (CA); Robert BRUNNER, Montreal (CA); Stephane LESSARD, Mirabel (CA)

(72) Inventors: Mehrdad MIR SHAFIEI, Montreal (CA); Robert BRUNNER, Montreal (CA); Stephane LESSARD, Mirabel (CA)

(73) Assignee: TELEFONAKTIEBOLAGET LM ERICSSON (PUBL), Stockholm (SE)

(21) Appl. No.: 15/544,797

(22) PCT Filed: Feb. 10, 2015
(86) PCT No.: PCT/IB2015/051002

§ 371 Date: Jul. 19, 2017

(51) Int. Cl. G02B 6/43; G02B 6/13; G02B 6/122

(52) U.S. Cl. CPC G02B 6/43; G02B 6/122; G02B 6/13

(57) ABSTRACT

The teachings herein provide a method and apparatus for interconnecting photonic devices using an advantageous technique that forms an end-to-end optical path between photonic circuits using photonic wire bonds and a bridging glass member. The photonic wire bonds couple the photonic circuits to respective ends of an optical waveguide formed in the glass member. The end-to-end optical path thus comprises a “composite” optical waveguide that includes the photonic wire bonds and the optical wave-guide. Advantageously, these composite optical waveguides are formed in-place according to a process whereby the various components are placed into at least a rough alignment on a substrate and, after deposition of polymer photoresist, a femtosecond laser beam traces the end-to-end optical path, thereby forming the respective photonic wire bonds and optical waveguide in place.

### TECHNICAL FIELD

The present invention generally relates to photonic circuits and particularly relates to interconnecting photonic circuits.

### BACKGROUND

The proliferation of photonic circuits across a range of technologies and applications brings with it a corresponding interest in developing advanced interconnects. An example advancement is seen in the U.S. Patent App. No. US20140161385A1 to Telefonaktiebolaget Lm Ericsson (Publ), which discloses an “optical transposer” that provides a number of interconnection advantages for photonic circuits. Among those advantages, the optical transposer, e.g., a glass member, includes a receptacle or recess for seating an optical die into alignment with optical waveguides formed within the transposer.

Although glass waveguides of the sort proposed in the above-identified application have a number of advantages, including low loss, it is recognized herein that certain characteristics limit their use. For example, the requirement for having a small refractive index change in the waveguide limits the bending radius of the glass waveguides to centimeters. More recent advances involving so called “photonic wire bonds” or “PWBs” address the bending radius issues associated with glass waveguides. The interested reader may refer to U.S. Pat. No. 8,903,205 B2 to Koos et al., for example details regarding the use of photonic wire bonds in interconnecting optical chips.

However, the use of photonic wire bonds introduces a number of new challenges and limitations. For example, it is recognized herein that photonic wire bonds are in practice limited to relatively short lengths, e.g., about 50 μm. Distances that small severely limit the use of photonic wire bonds in interconnecting photonic circuits, e.g., in multi-chip packages.

### SUMMARY

The teachings herein provide a method and apparatus for interconnecting photonic devices using an advantageous technique that forms an end-to-end optical path between photonic circuits using photonic wire bonds and a bridging glass member. The photonic wire bonds couple the photonic circuits to respective ends of an optical waveguide formed in the glass member. The end-to-end optical path thus comprises a “composite” optical waveguide that includes the photonic wire bonds and the optical waveguide. Advantageously, these composite optical waveguides are formed in-place according to a process whereby the various components are placed into at least a rough alignment on a substrate and, after deposition of polymer photoresist, a femtosecond laser beam traces the end-to-end optical path, thereby forming the respective photonic wire bonds and optical waveguide in place.

In an example embodiment, a photonic device assembly includes a substrate having a substrate surface, and first and second photonic circuits that are positioned on the substrate surface. The assembly further includes a glass body positioned on the substrate surface in proximity to the first and second photonic circuits. Still further, the assembly includes a first composite optical waveguide providing an end-to-end optical path between the first photonic circuit and the second photonic circuit.

The composite optical waveguide includes a first photonic wire bond that is formed from polymer photoresist via femtosecond-laser inscription and operative to optically couple the first photonic circuit to a first alignment point on the glass body, and a second photonic wire bond that is also formed from polymer photoresist via femtosecond-laser inscription and is operative to optically couple the second photonic circuit to a second alignment point on the glass body. The composite optical waveguide further includes an optical waveguide formed in the glass body via femtosecond-laser inscription. Here, the optical waveguide formed in the glass body bridges between the first and second alignment points and thereby optically couples the first photonic wire bond to the second photonic wire bond.

In a corresponding embodiment, an example method of fabricating a photonic device assembly uses an advantageous femtosecond-laser inscription process that forms composite optical waveguides in place. The assembly includes first and second photonic circuits positioned on a surface of a substrate, and further includes a glass body positioned on the surface of the substrate. Correspondingly, the example method is implemented by a laser-inscribing apparatus and includes obtaining a data set of three-dimensional coordinates that describes an end-to-end optical path optically coupling the first photonic circuit with the second photonic circuit. Here, the end-to-end optical path is to be formed as a composite optical waveguide.

According to the method, the composite optical waveguide includes a first photonic wire bond optically coupling the first photonic circuit to a first alignment point on the glass body, a second photonic wire bond optically coupling the second photonic circuit to a second alignment point on the glass body, and an optical waveguide formed in the glass body and bridging between the first and second alignment points. Correspondingly, the method includes depositing polymer photoresist in fluid communication with the glass body and the first and second photonic circuits and causing a femtosecond laser beam to trace a trajectory defined by the data set of three-dimensional coordinates and thereby form the first and second photonic wire bonds and the optical waveguide.

For forming the composite optical waveguide, the method includes operating the femtosecond laser beam according to one or more first control settings for forming the photonic wire bonds and according to one or more second control settings for forming the optical waveguide, to account for material properties of the polymer photoresist and material properties of the glass body. That is, the one or more control settings are adapted so that the femtosecond-laser inscription process is “tuned” to the respective materials involved in the composite optical waveguide.

For example, the inscription process is configured for inscribing in the polymer photoresist and a first one of the photonic wire bonds is formed from a first photonic circuit to an entry point into the glass body. The inscription process is then adapted for inscribing in the glass body and an optical waveguide is inscribed from the entry point, to a desired exit point from the glass body. There, the inscription process is re-adapted for inscribing in the polymer photoresist and the second photonic wire bond is formed from the exit point to a second photonic circuit.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a diagram of an embodiment of a photonic device assembly that provides a composite optical waveguide including polymer photo wire bonds and an interposed optical waveguide in a glass body.

FIG. 2 is a diagram of one embodiment of a path representation of a composite optical waveguide having polymer and glass interface points.

FIG. 3 is a diagram of one embodiment of a data set of three-dimensional coordinates, including path data and interface alignment data, for a composite optical waveguide.

FIG. 4 is a diagram of one embodiment of a laser-inscribing apparatus, such as may be used to form composite optical waveguides.

FIG. 5 is a logic flow diagram of one embodiment of a method of fabricating a photonic device assembly with one or more composite optical waveguides.

FIG. 6 is a diagram of another embodiment of a photonic device assembly having a plurality of photonic circuit pairs and a corresponding plurality of composite optical waveguides.

### DETAILED DESCRIPTION

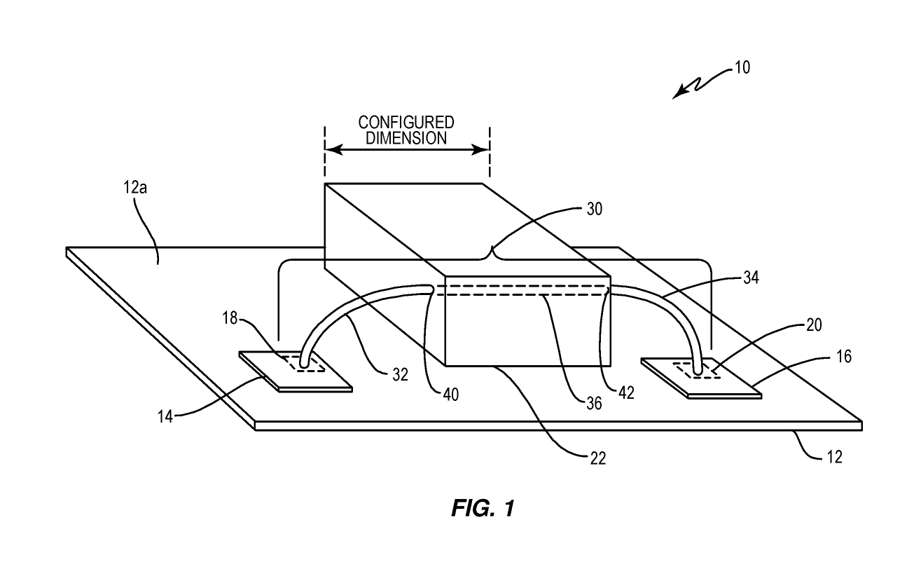

FIG. 1 illustrates an example photonic device assembly 10 according to one embodiment of the teachings herein. The photonic device assembly includes a substrate 12 having a substrate surface 12a, and first and second photonic circuits 18 and 20, respectively. The first and second photonic circuits 18 and 20 are positioned on the substrate surface 12a, and may be included in or carried by photonic dies 14 and 16, respectively.

The photonic device assembly 10hereafter “assembly 10”further includes a glass body 22 that is positioned on the substrate surface 12a in proximity to the first and second photonic circuits 18 and 20. Further, one sees a first “composite” optical waveguide 30 providing an end-to-end optical path between the first photonic circuit 18 and the second photonic circuit 20. The term “composite” here emphasizes that the composite optical waveguide 30 is made up of various elements or parts, including a first photonic wire bond 32, a second photonic wire bond 34, and an optical waveguide 36.

The first photonic wire bond 32 is formed from polymer photoresist via femtosecond-laser inscription and is operative to optically couple the first photonic circuit 18 to a first alignment point 40 on the glass body 22. Likewise, the second photonic wire bond 34 is formed from polymer photoresist via femtosecond-laser inscription and is operative to optically couple the second photonic circuit 20 to a second alignment point 42 on the glass body 22. Complementing this arrangement of photonic wire bonds 32 and 34, the optical waveguide 36 is formed in the glass body 22 via femtosecond-laser inscription and it bridges between the first and second alignment points 40 and 42, and thereby optically couples the first photonic wire bond 32 to the second photonic wire bond 34.

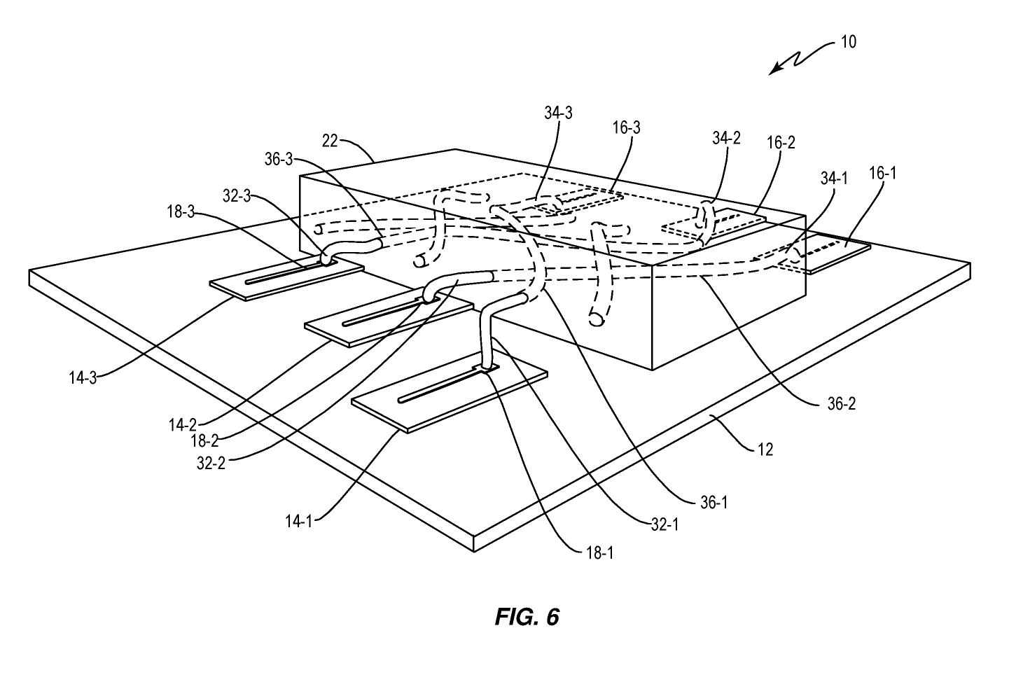

In some embodiments and with momentary reference to FIG. 6, the first and second photonic circuits 18 and 20 are one circuit pair among of a plurality of circuit pairs 18 and 20 carried on the substrate 12. In such embodiments, each circuit pair 18 and 20 is optically coupled together via a corresponding further composite optical waveguide 30 that is constructed in like manner as the first composite optical waveguide 30 seen in FIG. 1. Note that the general attribution of reference numbers 18 and 20 to any given photonic circuit pair does not mean that all such circuit pairs are alike. Indeed, the assembly 10 may interconnect a variety of photonic circuit types.

In a further example configuration, the assembly 10 further includes a protective encapsulate or cladding at least covering the photonic wire bonds 32 and 34. The encapsulate is, for example, poured or deposited over the photonic wire bonds 32 and 34 after removing the unexposed photoresist surrounding them. As will be appreciated, encapsulation provides protection and additional structural support for the photonic wire bonds 32 and 34.

The “configured dimension” annotated in FIG. 1 highlights one of the advantageous aspects of the assembly 10. Namely, it is recognized herein that the photonic wire bonds 32 and 34 can be limited to advantageously short lengths by using the glass body 22 as a bridging member between the photonic circuits 18 and 20. For a given distance between respective photonic circuits 18 and 20, the glass body 22 can be dimensioned so that the optical waveguide 36 formed in the glass body 22 constitutes the longest segment or portion of the composite optical waveguide 30. Indeed, FIG. 1 is, of course, not drawn to scale, and it will be appreciated that the involved extents of the glass body 22 may extend very close to the photonic circuits 18 and 20, thus leaving only very small distances to be spanned by the photonic wire bonds 32 and 34. In particular, in some embodiments, the glass body 22 is dimensioned so that the lengths of the first and second photonic wire bonds 32 and 34 do not exceed a defined maximum length.

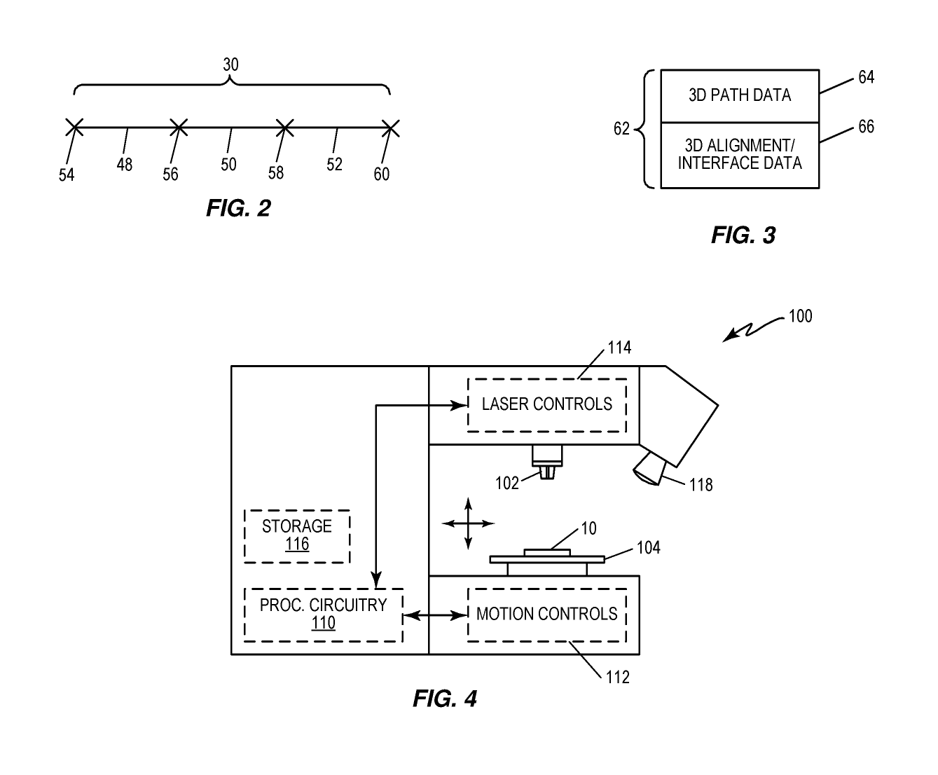

To better understand these optical-path features and advantages, FIG. 2 provides a symbolic or abstracted representation of the contemplated composite optical waveguide 30. According to this representation, the composite optical waveguide 30 includes a first path segment 48, a second path segment 50, and a third path segment 52. While drawn as lines, the reader will understand that the path segments 48, 50 and 52 are, in fact, three-dimensional trajectories and may describe compound curvatures within XYZ coordinates.

Further according to the representation depicted in FIG. 2, one sees that each path segment begins and ends in an interface point 54, 56, 58 or 60. For example, the interface point 54 represents the junction between one end of the first photonic wire bond 32 and the corresponding optical entry/exit point of the photonic circuit 18. The interface point 56 represents the junction between the other end of the first photonic wire bond 32 and the corresponding optical entry/exit point on the glass body 22, e.g., the alignment point 40 seen in FIG. 1. The interface point 58 represents the junction between one end of the second photonic wire bond 34 and the corresponding optical entry/exit point on the glass body 22, e.g., the alignment point 42 seen in FIG. 1. Finally, the interface point 60 represents the junction between the other end of the second photonic wire bond 34 and the corresponding optical entry/exit point of the photonic circuit 20.

FIG. 3 illustrates a corresponding data set or structure 62, which includes three-dimensional path data 64 and three-dimensional alignment/interface data 66. The path data 64 describes the path segments 48, 50 and 52 in numeric form, such as in a form suitable for machine control, for fabrication of the assembly 10. Correspondingly, the alignment/interface data 66 describes the coordinates or positions within the involved three-dimensional coordinate space that are associated with the interface points 54, 56, 58 and 60.

The data set 62 is used in a laser-inscribing apparatus, such as in the example apparatus 100 illustrated in FIG. 4. The apparatus 100 includes an emitting tip 102 for laser-beam emission, and further includes a jig or support 104, for aligning, retaining and moving the assembly 10. That is, the example apparatus 100 moves the assembly 10 relative to the laser beam rather than moving the laser beam. Of course, the opposite arrangement may be used and the teachings herein are not limited to the illustrated example

The apparatus 100 further includes processing circuitry 110, motion controls 112, laser controls 114, and one or more machine-vision or scanning cameras 118. The processing circuitry 110 comprises, for example, computer circuitry comprising one or more microprocessor-based circuits. The processing circuitry 110 is configured to control the motion controls 112, to control the relative movement, e.g., in three dimensions, between the assembly 10 and the laser beam emitted from the emitting tip 102. The motion controls 112 will be understood as comprising one or more motorized assemblies for raising, lowering and translating the jig 104and, thereby, the assembly 10relative to the emitting tip 102.

Further, the processing circuitry 110 is configured to control the laser beam(s) emitted from the emitting tip 102, via one or more laser controls 114 that are configured to set or adjust one or more laser beam settings, such as the repetition rate and duty cycle of laser beam pulses. Additionally, the laser controls 114 in at least some embodiments provide for power or intensity control, wavelength control, and on/off control. In at least one embodiment, one or more of these parameters is adjustable on-the-fly, e.g., the pulse characteristics and/or beam wavelength are adaptable in real-time.

These various settings, e.g., desired parameter values, may be preconfigured and held in the storage 116, which is included in or accessible to the processing circuitry 110. The storage 116 also may provide non-transitory storage for computer program instructions which, when executed by the processing circuitry 110, configure the apparatus 100 to carry out the fabrication method contemplated herein.

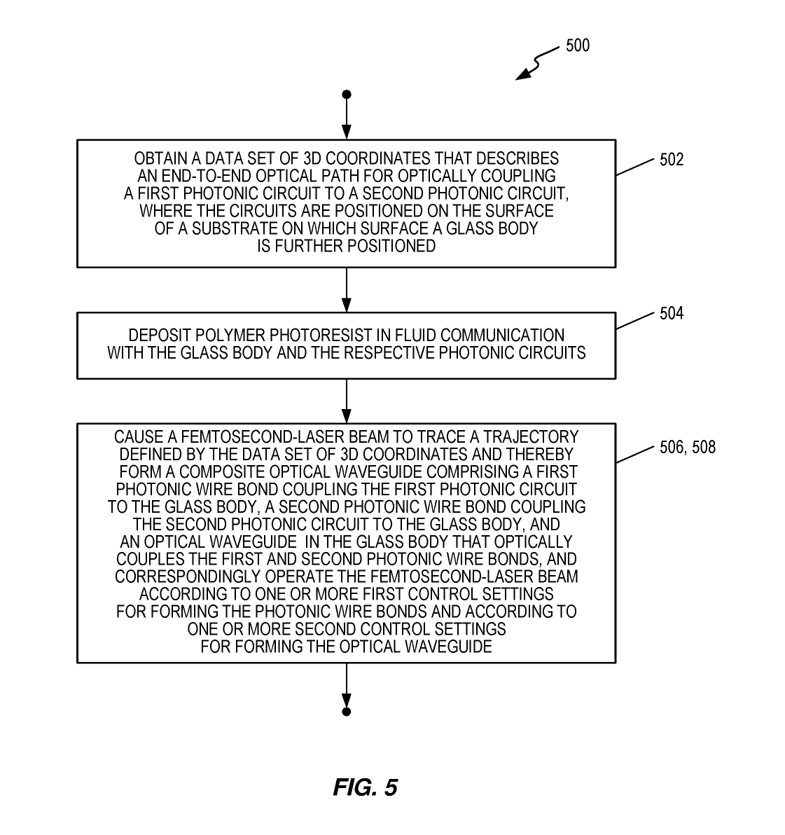

FIG. 5 illustrates such a method 500 according to one embodiment. Again, the assembly 10 of interest includes first and second photonic circuits 18 and 20 positioned on a surface 12a of a substrate 12, and further includes a glass body 22 positioned on the surface 12a of the substrate 12. The method 500 is implemented by a laser-inscribing apparatus, such as the example apparatus 100 of FIG. 4, and it includes obtaining (Block 502) a data set of three-dimensional coordinates that describes an end-to-end optical path optically coupling the first photonic circuit 18 with the second photonic circuit 20. The data set 62 seen in FIG. 3 provides a working example of the data set at issue here, and it shall be understood that the end-to-end optical path at issue is to be formed as a composite optical waveguide 30, as described before. Namely, the composite optical waveguide 30 includes a first photonic wire bond 32 optically coupling the first photonic circuit 18 to a first alignment point 40 on the glass body 22, a second photonic wire bond 34 optically coupling the second photonic circuit 20 to a second alignment point 42 on the glass body 22, and an optical waveguide 36 formed in the glass body 22 bridging between the first and second alignment points 40 and 42.

The method 500 further includes depositing (Block 504) polymer photoresist in fluid communication with the glass body 22 and the first and second photonic circuits 18 and 20. For example, the apparatus 100 includes a photoresist deposition mechanism—not explicitly shown—operated under control of the processing circuitry 110or the polymer photoresist is deposited on the assembly 10 in advance of placing it into the jig 104.

In either case, the method 500 includes causing (Block 506) a femtosecond laser beam to trace a trajectory defined by the data set 62 of three-dimensional coordinates and thereby forming the first and second photonic wire bonds 32 and 34 and the optical waveguide 36. The method 500 correspondingly includes operating (Block 508) the femtosecond laser beam according to one or more first control settings for forming the photonic wire bonds 32 and 34 and according to one or more second control settings for forming the optical waveguide 36, to account for material properties of the polymer photoresist and material properties of the glass body 22.

In one or more embodiments, obtaining (Block 502) the data set 62 of three-dimensional coordinates comprises obtaining alignment data 66 for an interface point 54 between the first photonic wire bond 32 and the first photonic circuit 18, for an interface point 56 between the first photonic wire bond 32 and the glass body 22, for an interface point 58 between the glass body 22 and the second photonic wire bond 34, and for an interface point 60 between the second photonic wire bond 34 and the second photonic circuit 20. The method 500 correspondingly includes generating path data 64 describing three-dimensional path trajectories interconnecting the interfaces, e.g., describing the path segments 48, 50 and 52 seen in FIG. 3.

In an example implementation, generating the path data 64 comprises obtaining pre-calculated path data and modifying the pre-calculated path data to account for discrepancies between actual alignments detected between the first and second photonic circuits 18 and 20 and the glass body 22, as positioned on the surface 12a of the substrate 12 and nominal alignments assumed for the pre-calculated path data. This approach advantageously allows for the component parts of the assembly 10 to be positioned on the substrate surface 12a according to a coarser or less precise alignment than would otherwise be required. So long as the placements substantially conform to the nominal placements, the apparatus 100 can dynamically adapt the default path data to compensate for differences between the actual positions and alignments of the involved components—e.g., the photonic circuits 18 and 20 and the glass body 22—and, possibly, any jig misalignments.

Here, the method 500 in at least one embodiment obtains (Block 502) the data set 62 of three-dimensional coordinates by computing the data set on fly from scan data acquired by scanning the substrate 12 with the photonic circuits 18 and 20 and glass body 22 positioned thereon. Alternatively, the method 500 obtains the data set 62 by retrieving the data set from the storage 116, which shall be understood as an electronic data store. As a further alternative, the method 500 uses a combination of on-the-fly computation and data store retrieval_13 e.g., it retrieves a nominal or starting data set and then adapts it based on scanning the assembly 10 after mounting in the jig 104.

As for adapting the laser beam emitted from the emission tip 102, the one or more first control settings comprise, in one or more embodiments, one or more first travel speed settings that are set in dependence on the material properties of the polymer photoresist. Correspondingly, the one or more second control settings comprise one or more second travel speed settings that are set in dependence on the material properties of the glass body 22. Additionally, or alternatively, the one or more first control settings comprise one or more first laser beam pulse-rate settings that are set in dependence on the material properties of the polymer photoresist, and the one or more second control settings comprise one or more second laser beam pulse-rate settings that are set in dependence on the material properties of the glass body 22. As a further addition or alternative, the one or more first control settings comprise one or more first laser beam frequency and/or power settings that are set in dependence on the material properties of the polymer photoresist, and the one or more second control settings comprise one or more second laser beam frequency and/or power settings that are set in dependence on the material properties of the glass body 22.

In one embodiment, the apparatus 100 is equipped with two separately selectable lasers, e.g., the emission tip 102 includes a shutter assembly that passes one beam or the other. One laser has its operating parameters tuned for inscribing the photo wire bonds 32 and 34 in polymer photoresist and the other laser has its operating parameters tuned for inscribing optical waveguides in the glass body 22. Thus, operating the femtosecond laser beam according to the one or more first control settings for forming the photonic wire bonds 32 and 34 and according to the one or more second control settings for forming the optical waveguide 36 comprises controlling the apparatus 100, for selection of the appropriate laser in dependence on which part of the composite optical path 30 is being scribed.

In another embodiment, the apparatus 100 provides an adjustable laser beam. Thus, operating the femtosecond laser beam according to the one or more first control settings for forming the photonic wire bonds 32 and 34 and according to the one or more second control settings for forming the optical waveguide 36 comprises controlling or operating the adjustable laser beam according to the one or more first control settings when inscribing the photonic wire bonds 32 and 34 and operating the adjustable laser beam according to the one or more second control settings when inscribing the optical waveguide 36.

As a non-limiting example, the selected or adapted laser beam for inscribing the photo wire bonds 32 and 34 has a pulse width of 120 femtoseconds and a repetition rate of approximately 100 MHz. The laser operates at a wavelength of 780 nm and provides for two-photon polymerization of the photoresist.

As a further non-limiting example, the selected or adapted laser beam for inscribing the optical waveguide 36 in the glass body 22 operates at a wavelength of 800 nm. Further, the laser beam uses femtosecond pulses at a 1 kHz to 250 kHz repetition rate.

In a further extension of the method 500, the femtosecond laser beam is operated without an air gap with respect to the polymer photoresist. This feature is accomplished by immersing at least the emitting tip 102 of a laser beam apparatus 100 into the polymer photoresist for inscribing the photonic wire bonds 32 and 34. As an alternative, operating the femtosecond laser beam without an air gap with respect to the polymer photoresist is accomplished in the context of the method 500 by covering the polymer photoresist in an overlaying layer of fluid having an optical index similar to that of the polymer photoresist, and immersing at least an emitting tip 102 of the apparatus 100 into the overlaying layer of fluid for inscribing the photonic wire bonds 32 and 34.

In either case, “immersing” the emitting tip 102 does not necessarily mean complete immersion of the full length of the emitting tip 102. Rather, it is sufficient to immerse just the distal end from which the laser beam is output.

Among the several advantages provided by the method and apparatus disclosed herein, the teachings provide a “single-step” process to interconnect photonic circuits, based on using a femtosecond laser to fabricate waveguides in glass and in polymer. Here, the “single-step” phrase denotes that the contemplated method allows one overall process to be used for scribing both the photonic wire bonds and the glass-based optical waveguide. The resulting assembly combines the best features of glass waveguides, including low loss, and photonic wire bonds, including the small bending radii achievable using them, and does so in a manner that allows the photonic wire bonds to be limited in length to targeted maximums even where the involved photonic circuits are displaced by a greater distance.

The contemplated method simplifies coupling and does not require further treatment of glass, for instance a trench to control a Total Internal Reflection, TIR, or a lens. Moreover, photonic circuits 18 and 20 and the glass body 22 do not need to be precisely aligned; instead, they can be placed on a substrate with moderate precision. Then, using machine vision or other scanning technologies, alignment marks on the photonic circuits 18 and 20 and possibly on the glass body 22 and substrate surface 12a are detected and used to compute the alignment/interface data 66i.e., the path segment junctions relating to the optical entry/exit points along the length of the composite optical waveguide 30. This data can then be used to generate or compensate the three-dimensional path data describing the path segment trajectories between the junctions.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A photonic device assembly comprising:
a substrate having a substrate surface;
first and second photonic circuits positioned on the substrate surface;
a glass body positioned on the substrate surface in proximity to the first and second photonic circuits; and
a first composite optical waveguide providing an end-to-end optical path between
the first photonic circuit and the second photonic circuit and comprising:
a first photonic wire bond formed from polymer photoresist via femtosecond-laser inscription and operative to optically couple the first photonic circuit to a first alignment point on the glass body;
a second photonic wire bond formed from polymer photoresist via femtosecond-laser inscription and operative to optically couple the second photonic circuit to a second alignment point on the glass body; and
an optical waveguide formed in the glass body via femtosecond-laser inscription and bridging between the first and second alignment points and thereby optically coupling the first photonic wire bond to the second photonic wire bond.

2. The photonic device assembly of claim 1, wherein the first and second photonic circuits are one circuit pair among of a plurality of circuit pairs carried on the substrate, and wherein each circuit pair is optically coupled together via a further composite optical waveguide constructed in like manner as said first composite optical waveguide.

3. The photonic device assembly of claim 1, further comprising a protective encapsulate or cladding at least covering the photonic wire bonds.

4. The photonic device assembly of claim 1, wherein the glass body is dimensioned so that the lengths of the first and second photonic wire bonds do not exceed a defined maximum length.

5. A method of fabricating a photonic device assembly that includes first and second photonic circuits positioned on a surface of a substrate, and further includes a glass body positioned on the surface of the substrate, said method implemented by a laser-inscribing apparatus and comprising:
obtaining a data set of three-dimensional coordinates that describes an end-to-end optical path optically coupling the first photonic circuit with the second photonic circuit, wherein the end-to-end optical path is to be formed as a composite optical waveguide that comprises:
a first photonic wire bond optically coupling the first photonic circuit to a first alignment point on the glass body;
a second photonic wire bond optically coupling the second photonic circuit to a second alignment point on the glass body; and
an optical waveguide formed in the glass body bridging between the first and second alignment points;
depositing polymer photoresist in fluid communication with the glass body and the first and second photonic circuits;
causing a femtosecond laser beam to trace a trajectory defined by the data set of three-dimensional coordinates and thereby forming the first and second photonic wire bonds and the optical waveguide; and
correspondingly operating the femtosecond laser beam according to one or more first control settings for forming the photonic wire bonds and according to one or more second control settings for forming the optical waveguide, to account for material properties of the polymer photoresist and material properties of the glass body.

6. The method of claim 5, wherein obtaining the data set of three-dimensional coordinates comprises:
obtaining alignment data for an interface point between the first photonic wire bond and the first photonic circuit, for an interface point between the first photonic wire bond and the glass body, for an interface point between the glass body and the second photonic wire bond, and for an interface point between the second photonic wire bond and the second photonic circuit; and
generating path data describing three-dimensional path trajectories interconnecting the interfaces.

7. The method of claim 6, wherein generating the path data comprises obtaining pre-calculated path data and modifying the pre-calculated path data to account for discrepancies between actual alignments detected between the first and second photonic circuits and the glass body as positioned on the surface of the substrate and nominal alignments assumed for the pre-calculated path data.

8. The method of claim 5, wherein the one or more first control settings comprise one or more first travel speed settings that are set in dependence on the material properties of the polymer photoresist, and wherein the one or more second control settings comprise one or more second travel speed settings that are set in dependence on the material properties of the glass body.

9. The method of claim 5, wherein the one or more first control settings comprise one or more first laser beam pulse-rate settings that are set in dependence on the material properties of the polymer photoresist, and wherein the one or more second control settings comprise one or more second laser beam pulse-rate settings that are set in dependence on the material properties of the glass body.

10. The method of claim 5, wherein the one or more first control settings comprise one or more first laser beam frequency and/or power settings that are set in dependence on the material properties of the polymer photoresist, and wherein the one or more second control settings comprise one or more second laser beam frequency and/or power settings that are set in dependence on the material properties of the glass body.

11. The method of claim 5, wherein operating the femtosecond laser beam according to the one or more first control settings for forming the photonic wire bonds and according to the one or more second control settings for forming the optical waveguide comprises controlling a laser apparatus having two separately selectable lasers, one having operating parameters set for polymer photoresist and one having operating parameters set for the glass body.

12. The method of claim 5, wherein operating the femtosecond laser beam according to the one or more first control settings for forming the photonic wire bonds and according to the one or more second control settings for forming the optical waveguide comprises controlling a laser apparatus having an adjustable laser beam and correspondingly operating the adjustable laser beam according to the one or more first control settings when inscribing the photonic wire bonds and operating the adjustable laser beam according to the one or more second control settings when inscribing the optical waveguide.

13. The method of claim 5, further comprising operating the femtosecond laser beam without an air gap with respect to the polymer photoresist, by immersing at least an emitting tip of a laser beam apparatus into the polymer photoresist for inscribing the photonic wire bonds.

14. The method of claim 5, further comprising operating the femtosecond laser beam without an air gap with respect to the polymer photoresist, by covering the polymer photoresist in an overlaying layer of fluid having an optical index similar to that of the polymer photoresist, and immersing at least an emitting tip of a laser beam apparatus into the overlaying layer of fluid for inscribing the photonic wire bonds.

15. The method of claim 5, wherein obtaining the data set of three-dimensional coordinates comprises computing the data set on fly from scan data acquired by scanning the substrate with the photonic circuits and glass body positioned thereon, or by retrieving the data set from an electronic data store in or accessible to the laser-inscribing apparatus, or by a combination of on-the-fly computation and data store retrieval.
